(19) United States
(12) Patent Application Publication
(10) Pub. No.: US 2021/0302809 A1
(43) Pub. Date: Sep. 30, 2021

(54) MAN-HOLE CAMERA SYSTEM

(71) Applicant: KEVIN LEFFINGWELL, Phoenix, AZ (US)

(72) Inventor: KEVIN LEFFINGWELL, Phoenix, AZ (US)

(21) Appl. No.: 16/827,885

(22) Filed: Mar. 24, 2020

(51) Int. Cl. G03B 17/56

(52) U.S. Cl. CPC G03B 17/563

(57) ABSTRACT

The man-hole camera system is an image capture device. The man-hole camera system inserts into an underground space maintained by the utility system through a man-hole. The man-hole camera system captures images from within the underground space maintained by the utility system for subsequent analysis and review. The man-hole camera system comprises a telescopic handle, a semitransparent shield, a mounting prism, and a camera apparatus. The camera apparatus mounts on and in the mounting prism. The mounting prism inserts into the semitransparent shield. The telescopic handle attaches to the mounting prism. The telescopic handle lowers the mounting prism through the man-hole into the underground space maintained by the utility system. The camera apparatus captures the images from the underground space maintained by the utility system and transmits

### CROSS REFERENCES TO RELATED APPLICATIONS

Not Applicable

### STATEMENT REGARDING FEDERALLY SPONSORED RESEARCH Not Applicable

### REFERENCE TO APPENDIX

Not Applicable

### BACKGROUND OF THE INVENTION

### Field of the Invention

The present invention relates to the field of fixed constructions including hydraulic engineering and associated component parts, more specifically, an apparatus for surveying a worksite before treatment. (E02E9/261)

### SUMMARY OF INVENTION

The man-hole camera system is configured for use with a man-hole of a utility system. The man-hole is an access point into an underground space maintained by the utility system. The man-hole camera system is an image capture device. The man-hole camera system inserts into the underground space maintained by the utility system through the man-hole. The man-hole camera system captures images from within the underground space maintained by the utility system for subsequent analysis and handle, a semitransparent shield, a mounting prism, and a camera apparatus. The camera apparatus mounts on and in the mounting prism. The mounting prism inserts into the semitransparent shield. The telescopic handle attaches to the mounting prism. The telescopic handle lowers the mounting prism through the man-hole into the underground space maintained by the utility system. The camera apparatus captures the images from the underground space maintained by the utility system and transmits those images to a personal data device.

These together with additional objects, features and advantages of the man-hole camera system will be readily apparent to those of ordinary skill in the art upon reading the following detailed description of the presently preferred, but nonetheless illustrative, embodiments when taken in conjunction with the accompanying drawings.

In this respect, before explaining the current embodiments of the man-hole camera system in detail, it is to be understood that the man-hole camera system is not limited in its applications to the details of construction and arrangements of the components set forth in the following description or illustration. Those skilled in the art will appreciate that the concept of this disclosure may be readily utilized as a basis for the design of other structures, methods, and systems for

It is therefore important that the claims be regarded as including such equivalent construction insofar as they do not depart from the spirit and scope of the man-hole camera system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a front view of an embodiment of the disclosure.

FIG. 2A is a cross-sectional view of an embodiment of the disclosure across 2A-2A as shown in FIG. 2.

FIG. 3 is a top view of an embodiment of the disclosure.

FIG. 4 is a bottom view of an embodiment of the

FIG. 5 is an exploded view of an embodiment of the disclosure.

FIG. 6 is an in-use view of an embodiment of the disclosure.

FIG. 7 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

Detailed reference will now be made to one or more potential embodiments of the disclosure, which are illustrated

The man-hole camera system 100 (hereinafter invention) is configured for use with a man-hole 181 of a utility system. The man-hole 181 is an access point into an underground space maintained by the utility system. The invention 100 is an image capture device. The invention 100 inserts into the underground space maintained by the utility system through the man-hole 181. The invention 100 captures images from within the underground space maintained by the utility system for subsequent analysis and review. The invention 100 comprises a telescopic handle 101, a semitransparent shield 102, a mounting prism 103, and a camera apparatus 104. The camera apparatus 104 mounts on and in the mounting prism 103. The mounting prism 103 inserts into the semitransparent shield 102. The telescopic handle 101 attaches to the mounting prism 103. The telescopic handle 101 lowers the mounting prism 103 through the man-hole 181 into the underground space maintained by the utility system. The camera apparatus 104 captures the images from the underground space maintained by the utility system and transmits those images to a personal data device 161.

The telescopic handle 101 is a mechanical structure. The telescopic handle 101 is a composite prism structure. The telescopic handle 101 is an extension structure. The reach of the telescopic handle 101 allows the camera apparatus 104 to be system through the man-hole 181 from the surface. The telescopic handle 101 is a telescopic structure. The span of the length of the center axis of the composite prism structure of the telescopic handle 101 is adjustable.

The telescopic handle 101 is a telescopic structure that comprises a first arm 111, a second arm 112, and a first detent 121. The first detent 121 is a mechanical device that locks and secures the first arm 111 to the second arm 112. The first arm 111 is a hollow prism that is further defined with an inner dimension. The second arm 112 is a hollow prism that is further defined with an outer dimension. The second arm 112 is geometrically similar to the first arm 111. The span of the outer dimension of the second arm 112 is lesser than the span of the inner dimension of the first arm 111 such that the second arm 112 inserts into the first arm 111 in a telescopic fashion to form a composite prism structure.

The span of the length of the telescopic handle 101 adjusts by adjusting the relative position of the second arm 112 within the first arm 111. The position of the second arm 112 relative to the first arm 111 is held in position using the first detent 121. The first detent 121 is selected from the group consisting of a cotter pin, a G snap collar, a cam lock collar, a threaded

The telescopic handle 101 is a telescopic structure that further comprises a third arm 113, and a second detent 122. The second detent 122 is a mechanical device that locks and secures the third arm 113 to the second arm 112. The second arm 112 is a hollow prism that is further defined with an inner dimension. The third arm 113 is a hollow prism that is further defined with an outer dimension. The third arm 113 is geometrically similar to the second arm 112. The span of the outer dimension of the third arm 113 is lesser than the span of the inner dimension of the second arm 112 such that the third arm 113 inserts into the second arm 112 in a telescopic fashion to form a composite prism structure.

The span of the length of the telescopic handle 101 adjusts by adjusting the relative position of the third arm 113 within the second arm 112. The position of the third arm 113 relative to the second arm 112 is held in position using the second detent 122. The second detent 122 is selected from the group consisting of a cotter pin, a G snap collar, a cam lock collar, a threaded clutch, a split collar lock, and a spring loaded ball lock.

The first arm 111 further comprises a grip 141. The grip 141 is a structure that attaches to the end of the first arm 111 accommodation that allows for the manipulation of the invention 100.

The semitransparent shield 102 is a prism-shaped structure. The semitransparent shield 102 has a tubular shape. The semitransparent shield 102 removably attaches to the mounting prism 103. The semitransparent shield 102 is geometrically similar to the mounting prism 103 such that the mounting prism 103 inserts into the semitransparent shield 102. The semitransparent shield 102 is formed from a semitransparent material.

When the semitransparent shield 102 encloses the mounting prism 103 and the camera apparatus 104, the illumination generated by the camera apparatus 104 is scattered as it passes through the semitransparent shield 102. The scattering of the light by the semitransparent shield 102 creates a diffused illumination that reduces the shadows in the images that are captured by the camera apparatus 104. When the semitransparent shield 102 is removed from the mounting prism 103 and the camera apparatus 104, a greater level of illumination is generated by the camera apparatus 104. The greater generated illumination allows the camera apparatus 104 to: a) capture sharper images; while, b) increasing the risk that shadows will be interpreted

The semitransparent shield 102 further comprises a latch 151. The latch 151 is a mechanical device that secures the semitransparent shield 102 to the mounting prism 103 when the mounting prism 103 is contained within the hollow interior of the semitransparent shield 102.

The mounting prism 103 is a housing. The mounting prism 103 is a hollow prism-shaped structure. The mounting prism 103 is geometrically similar to the semitransparent shield 102 such that the mounting prism 103 inserts into the semitransparent shield 102.

The mounting prism 103 is a rigid structure. The mounting prism 103 contains the camera apparatus 104. The mounting prism 103 is formed with all apertures and form factors necessary to allow the mounting prism 103 to accommodate the use, the operation, and the external connections of the camera apparatus 104. Methods to form a mounting prism 103 suitable for the purposes described in this disclosure are well-known and documented in the mechanical arts.

The camera apparatus 104 is an electric device. The camera apparatus 104 is a sensor. The camera apparatus 104 inserts through the man-hole 181 into the underground space maintained by the utility system. The camera apparatus 104 is an image capture device. The camera apparatus 104 illuminates the underground space maintained by the utility system. The camera apparatus 104 captures images from the underground space maintained by the utility system for analysis and review. The camera apparatus 104 comprises a logic module 131, a communication module 132, a plurality of LEDs 133, a motor structure 134, and an image sensor 135. The communication module 132 is configured for use with a personal data device 161. The communication module 132 further comprises a wireless communication link 162. The logic module 131, the communication module 132, the plurality of LEDs 133, the motor structure 134, and the image sensor 135 are electrically interconnected.

The personal data device 161 transmits operating instructions to the camera apparatus 104. The personal data device 161 receives images from the camera apparatus 104. The personal data device 161 is a programmable electrical device that provides data management and communication services through one or more functions referred to as an application. The application is a set of logical operating instructions that are performed by the personal data device 161. The addition of an application will provide increased functionality for the personal data device 161. This disclosure assumes that an application exists for the purpose of interacting with the invention 100. Methods to design and implement an application on a personal data device 161 are well known and documented in the electrical arts.

The logic module 131 is a readily and commercially available programmable electronic device that is used to manage, regulate, and operate the camera apparatus 104. Depending on the specific design and the selected components, the logic module 131 can be a separate component within the camera apparatus 104 or the functions of the logic module 131 can be incorporated into another component within the camera apparatus 104. The communication module 132 is a wireless electronic communication device that allows the logic module 131 to wirelessly communicate with a locally presented device such as a personal data device 161. Specifically, the communication module 132 establishes a wireless communication link 162 between the camera apparatus 104 and the personal data device 161 or other locally presented device. In the first potential embodiment of the disclosure, the communication module 132 supports a communication protocol selected from the group consisting of a WiFi™ protocol or a Bluetooth™ protocol.

The logic module 131 controls the operation of the communication module 132. The logic module 131 controls the operation of the plurality of LEDs 133. The logic module 131 controls the operation of the motor structure 134. The logic module 131 controls the operation of the image sensor 135. The personal data device 161 uses the wireless communication link 162 to transmit operating instruction to the logic module 131 through the communication module 132.

The logic module 131 receives and processes the captured images generated by the image sensor 135. The logic module 131 transmits the images captured from the image sensor 135 to the personal data device 161 using the communication module 132 and the wireless communication link 162. The logic module 131 controls the illumination generated by the camera apparatus 104 by controlling the operation of the plurality of LEDs 133. The logic module 131 controls the positioning of the field of view of the image sensor 135 by controlling the operation of the motor structure 134. Specifically, the logic module 131 controls an axis of rotation of the motor structure 134 such that the field of view of the image sensor 135 rotates around the center axis of the mounting prism 103.

Each of the plurality of LEDs 133 is an electric circuit element. The plurality of LEDs 133 generate a field of illumination within the underground space maintained by the utility system. Each LED selected from the plurality of LEDs 133 illuminates when an electric current passes through the selected LED. The plurality of LEDs 133 generates an illumination that allows the image sensor 135 to capture one or more images of the underground space maintained by the utility system.

The motor structure 134 is an electromechanical device. The motor structure 134 is a rotating device. The image sensor 135 attaches to the motor structure 134 such that the rotation of the motor structure 134 will rotate the field of view of the image sensor 135 around an axis of rotation that is aligned with the center axis of the prism structure of the mounting prism 103. The motor structure 134 rotates the field of view of the image sensor 135 by rotating the image sensor 135 around a full 360 degree arc centered on the axis of rotation. The motor structure 134 further comprises a servo motor 171 and a motor controller 172.

The servo motor 171 is an electric motor. The servo motor 171 is a rotating device. The servo motor 171 is designed for use in electrically controlling the angle of a first object relative to a second object. The servo motor 171 attaches to a congruent end of the mounting prism 103 such that the rotation of the servo motor 171 aligns with the center axis of the mounting prism 103. The servo motor 171 is defined elsewhere in this disclosure. The motor controller 172 is an electric circuit that controls the speed of rotation, the direction of rotation, and the angular position of the rotor of the servo motor 171. The motor controller 172 receives inputs from the logic module 131 and converts those inputs into the mechanical actions taken by the servo motor 171. The motor controller 172 is defined elsewhere in this disclosure.

The image sensor 135 is an electric sensor. The image sensor 135 receives light from the exterior of the image sensor 135 and converts the received light into a digital representation of sufficient detail to allow the logic module 131 to transmit a reproduction of the source of the captured light to the personal data device 161. The image sensor 135 transmits the captured images to the logic module 131. The image sensor 135 attaches to the motor structure 134 such that the motor structure 134 will rotate the image sensor 135. Specifically, the image sensor 135 attaches directly to the servo motor 171 of the motor structure 134.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Bluetooth™: As used in this disclosure, Bluetooth™ is a standardized communication protocol that is used to wirelessly interconnect electronic devices.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Communication Link: As used in this disclosure, a communication link refers to the structured exchange of data between two objects.

Composite Prism: As used in this disclosure, a composite prism refers to a structure that is formed from a plurality of structures selected from the group consisting of a prism structure and a pyramid structure. The plurality of selected structures may or may not be truncated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Correspond: As used in this disclosure, the term correspond is used as a comparison between two or more objects wherein one or more properties shared by the two or more objects match, agree, or align within acceptable manufacturing tolerances.

Detent: As used in this disclosure, a detent is a device for positioning and holding a first object relative to a second object such that the position of the first object relative to the second object is adjustable.

Diode: As used in this disclosure, a diode is a two terminal semiconductor device that allows current flow in only one direction. The two terminals are called the anode and the cathode. Electric current is allowed to pass from the anode to the cathode.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Electric Motor: In this disclosure, an electric motor is a machine that converts electric energy into rotational mechanical energy. An electric motor typically comprises a stator and a rotor. The stator is a stationary hollow cylindrical structure that forms a magnetic field. The rotor is a magnetically active rotating cylindrical structure that is coaxially mounted in the stator. The magnetic interactions between the rotor and the stator physically causes the rotor to rotate within the stator thereby generating rotational mechanical energy. This disclosure assumes that the power source is an externally provided source of DC electrical power. The use of DC power is not critical and AC power can be used by exchanging the DC electric motor with an AC motor that has a reversible starter winding.

Extension Structure: As used in this disclosure, an extension structure is an inert physical structure that is used to extend or bridge the reach between any two objects.

Feedback: As used in this disclosure, feedback refers to a system, including engineered systems, or a subsystem further comprising an “input” and an “output” wherein the difference between the output of the engineered system or subsystem and a reference is used as, or fed back into, a portion of the input of the system or subsystem. Examples of feedback in engineered systems include, but are not limited to, a fluid level control device such as those typically used in a toilet tank, a cruise control in an automobile, a fly ball governor, a thermostat, and almost any electronic device that comprises an amplifier. Feedback systems in nature include, but are not limited to, thermal regulation in animals and blood clotting in animals (wherein the platelets involved in blood clotting release chemical to attract other platelets)

Field of Illumination: As used in this disclosure, a field of illumination refers to an area illuminated by electromagnetic radiation projected from an electrical device such as a lamp or transmission antenna.

Field of View: As used in this disclosure, a field of view refers to one or more angles which delimits an area from which electromagnetic radiation will be sensed by a person or an image sensor.

Form Factor: As used in this disclosure, the term form factor refers to the size and shape of an object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Grip: As used in this disclosure, a grip is an accommodation formed on or within an object that allows the object to be grasped or manipulated by a hand.

Handle: As used in this disclosure, a handle is an object by which a tool, object, or door is held or manipulated with the hand.

Housing: As used in this disclosure, a housing is a rigid structure that encloses and protects one or more devices.

Illumination: As used in this disclosure, illumination refers to electromagnetic radiation contained with an area. Illumination is a synonym for light, particularly in cases where a measure of the amount of visible electromagnetic radiation in a space is called for.

Image: As used in this disclosure, an image is an optical representation or reproduction of an indicia or of the appearance of something or someone. See indicia sentiment optical character recognition.

Image Sensor: As used in this disclosure, an image sensor receives light from the exterior of the image sensor and converts the received light into a digital representation of sufficient detail to allow a logic module to create and display a visual reproduction of the source of the captured light.

Latch: As used in this disclosure, a latch is a fastening or locking mechanism. The use of the term latch does not necessarily but often implies the insertion of an object into a notch or cavity.

LED: As used in this disclosure, an LED is an acronym for a light emitting diode. A light emitting diode is a diode that is also a light source.

Logic Module: As used in this disclosure, a logic module is a readily and commercially available electrical device that accepts digital and analog inputs, processes the digital and analog inputs according to previously specified logical processes and provides the results of these previously specified logical processes as digital or analog outputs. The disclosure allows, but does not assume, that the logic module is programmable.

Motor Controller: As used in this disclosure, a motor controller is an electrical device that is used to control the rotational speed, or simply the speed of the motor, and the direction of rotation of an electric motor. Motor controllers will generally receive one or more inputs which are used to determine the desired rotational speed and direction of rotation of the electric motor.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Pan: As used in this disclosure, a pan is a hollow and prism-shaped containment structure. The pan has a single open face. The open face of the pan is often, but not always, the superior face of the pan. The open face is a surface selected from the group consisting of: a) an end of the prism structure that forms the pan; and, b) a lateral face of the prism structure that forms the pan. A semi-enclosed pan refers to a pan wherein the closed end of prism structure of the pan and/or a portion of the lateral face of the pan is also open.

PDD: As used in this disclosure, PDD is an acronym for personal data device.

Perimeter: As used in this disclosure, a perimeter is one or more curved or straight lines that bounds an enclosed area on a plane or surface. The perimeter of a circle is commonly referred to as a circumference.

Personal Data Device: As used in this disclosure, a personal data device is a handheld logical device that is used for managing personal information and communication. Examples of personal data device include, but are not limited to, cellular phones, tablets, and smartphones. See logical device

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Protected Space: As used in this disclosure, a protected space is a negative space within which an object is stored. The protected space is enclosed by a boundary structure, often referred to as a guard that prevents impacts from damaging the object contained within the protected space.

Reach: As used in this disclosure, reach refers to a span of distance between any two objects.

Semitransparent: As used in this disclosure, semitransparent refers to an object that is partially transparent. By partially transparent is meant: a) that only a proportion of the light that strikes a semitransparent structure will pass through the semitransparent structure; and, b) that the light is scattered as it passes through the semitransparent structure such that objects cannot be clearly seen through the semitransparent structure.

Servo: As used in this disclosure, a servo refers to a device that incorporates a feedback mechanism or electrical circuit that allows for the precise angular or linear positioning of the device.

Servo Motor: As used in this disclosure, a servo motor is an electrical motor that further incorporates a feedback circuit that allows for the precise angular positioning of the electric motor.

Shell: As used in this disclosure, a shell is a structure that forms an outer covering intended to contain an object. Shells are often, but not necessarily, rigid or semi-rigid structures that are intended to protect the object contained within it.

Telescopic: As used in this disclosure, telescopic is an adjective that describes a composite prism structure made of hollow prism-shaped sections that fit or slide into each other such that the composite prism structure can be made longer or shorter by adjusting the relative positions of the hollow prism-shaped sections.

Transparent: As used in this disclosure, transparent refers to a material that allows light to pass through the material without significant scattering such that an object can be clearly seen through the material.

Tube: As used in this disclosure, the term tube is used to describe a rigid hollow prism-shaped device with two open ends. While tubes that are suitable for use in this disclosure are often used to transport or conveys fluids or gases, the purpose of the tubes in this disclosure are structural. In this disclosure, the terms inner dimension and outer dimension of a tube are used as they would be used by those skilled in the plumbing arts.

WiFi™: As used in this disclosure, WiFi™ refers to the physical implementation of a collection of wireless electronic communication standards commonly referred to as IEEE 802.11x.

Wireless: As used in this disclosure, wireless is an adjective that is used to describe a communication channel between two devices that does not require the use of physical cabling.

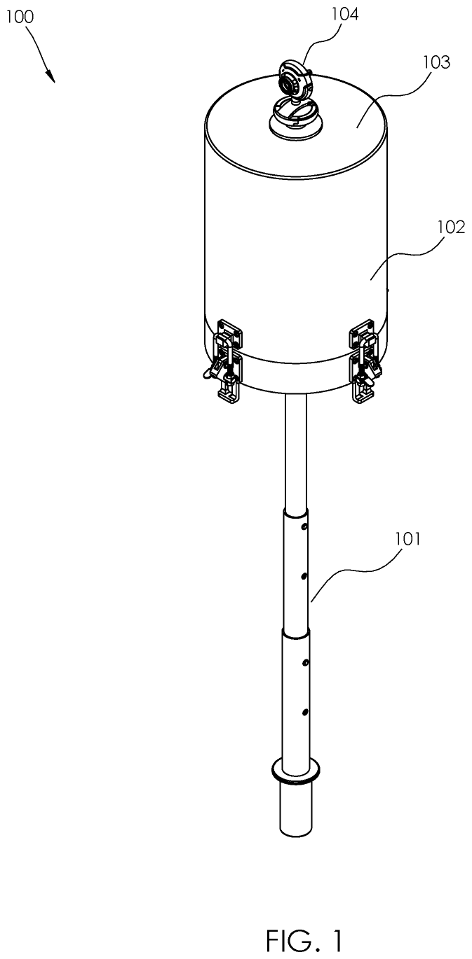

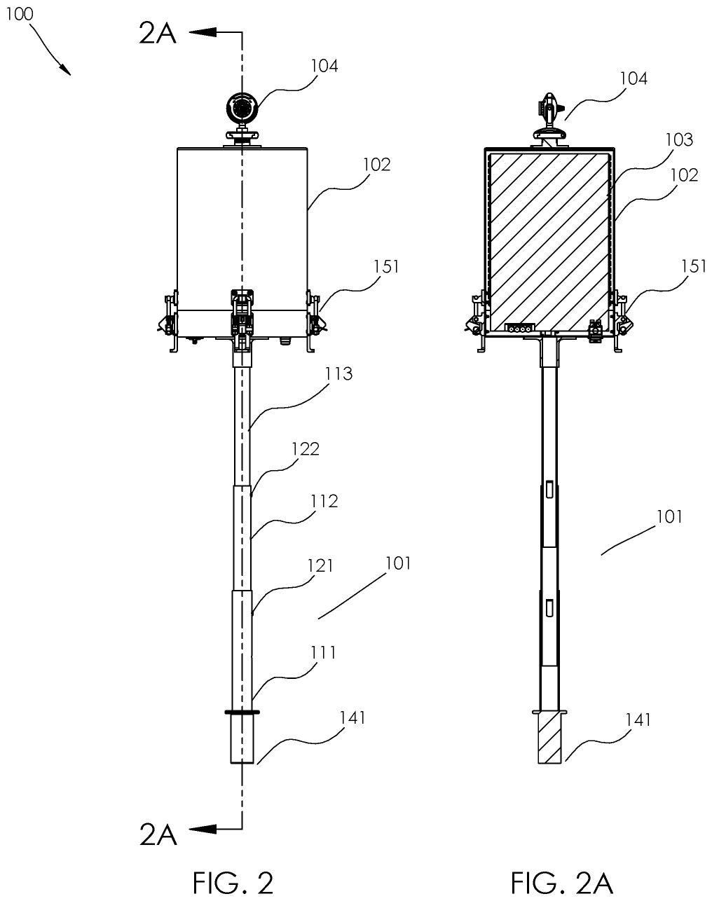

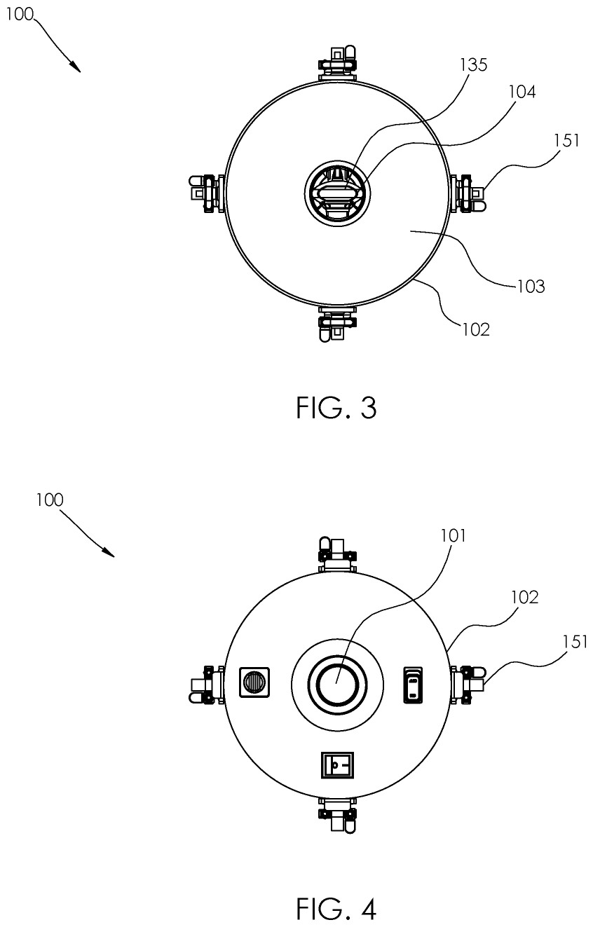

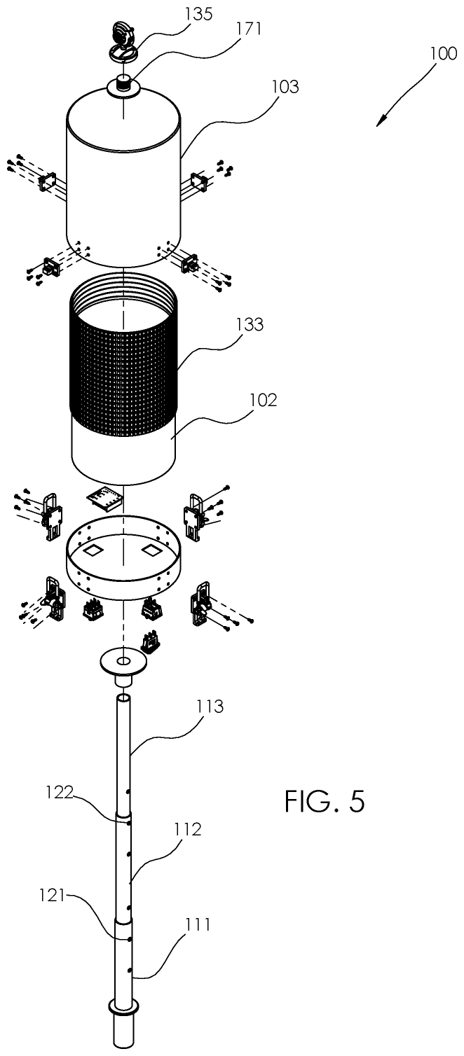

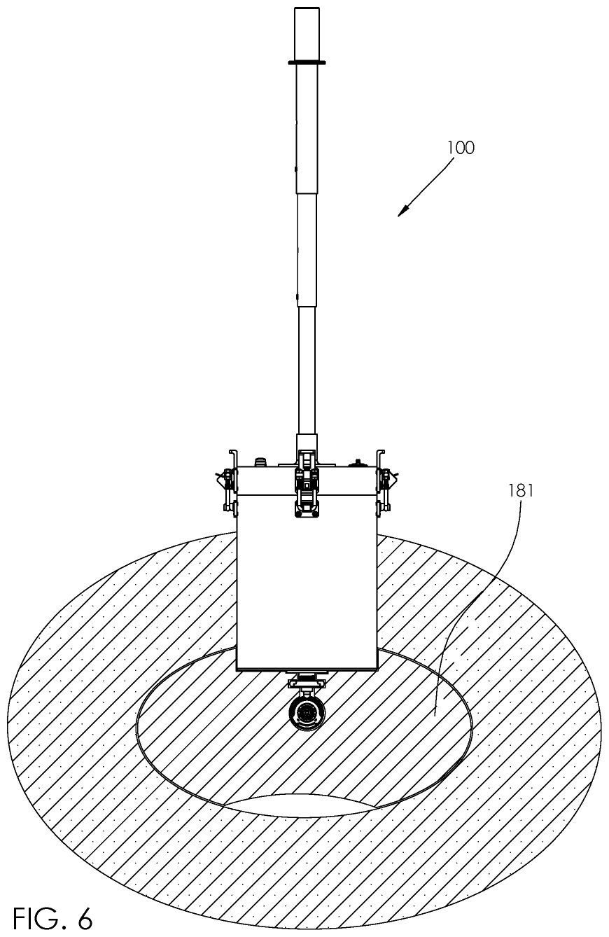

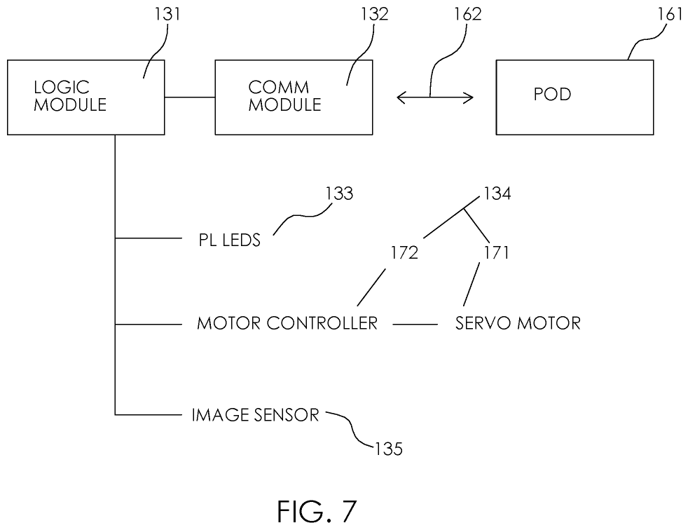

With respect to the above description, it is to be realized that the optimum dimensional relationship for the various components of the invention described above and in FIGS. 1 through 7 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

1. A man-hole camera system comprising
a telescopic handle, a semitransparent shield, a mounting prism, and a camera apparatus;
wherein the mounting prism inserts into the semitransparent shield;
wherein the telescopic handle attaches to the mounting prism;
wherein the man-hole camera system is configured for use with a man-hole of a utility system;
wherein the man-hole is an access point into an underground space maintained by the utility system;
wherein the man-hole camera system inserts into the underground space maintained by the utility system through the man-hole;
wherein the man-hole camera system is an image capture device;
wherein the man-hole camera system captures images from within the underground space maintained by the utility system for subsequent analysis and review;
wherein the camera apparatus captures the images from the underground space maintained by the utility system and transmits those images to a personal data device;
wherein the camera apparatus comprises a logic module, a communication module, a plurality of LEDs, a motor structure, and an image sensor;
wherein the logic module, the communication module, the plurality of LEDs, the motor structure, and the image sensor are electrically interconnected;
wherein the telescopic handle is a telescopic structure that comprises a first arm, a second arm, and a first detent;
wherein the first detent is a mechanical device that locks and secures the first arm to the second arm;
wherein the first arm is a hollow prism that is further defined with an inner dimension;
wherein the second arm is a hollow prism that is further defined with an outer dimension;
wherein the second arm is geometrically similar to the first arm;
wherein the span of the outer dimension of the second arm is lesser than the span of the inner dimension of the first arm such that the second arm inserts into the first arm in a telescopic fashion to form a composite prism structure;
wherein the span of the length of the telescopic handle adjusts by adjusting the relative position of the second arm within the first arm;
wherein the position of the second arm relative to the first arm is held in position using the first detent;
wherein the first arm further comprises a grip;
wherein the grip is a structure that attaches to the end of the first arm that is distal from the second arm;
wherein the semitransparent shield further comprises a latch;
wherein the latch is a mechanical device that secures the semitransparent shield to the mounting prism when the mounting prism is contained within the hollow interior of the semitransparent shield.

2. (canceled)

3. The man-hole camera system according to claim 1
wherein the telescopic handle is a mechanical structure;
wherein the telescopic handle is a composite prism structure;
wherein the telescopic handle is an extension structure;
wherein the reach of the telescopic handle allows the camera apparatus to be lowered into the underground space maintained by the utility system through the man-hole from the surface.

4. The man-hole camera system according to claim 3
wherein the telescopic handle is a telescopic structure;
wherein the span of the length of the center axis of the composite prism structure of the telescopic handle is adjustable.

5. The man-hole camera system according to claim 4
wherein the semitransparent shield is geometrically similar to the mounting prism such that the mounting prism inserts into the semitransparent shield;
wherein the semitransparent shield is formed from a semitransparent material.

6. The man-hole camera system according to claim 5
wherein the semitransparent shield is a prism-shaped structure;
wherein the semitransparent shield has a tubular shape;
wherein the semitransparent shield removably attaches to the mounting prism.

7. The man-hole camera system according to claim 6
wherein the mounting prism is a housing;
wherein the mounting prism is a hollow prism-shaped structure;
wherein the mounting prism is geometrically similar to the semitransparent shield such that the mounting prism inserts into the semitransparent shield.

8. The man-hole camera system according to claim 7
wherein the mounting prism is a rigid structure;
wherein the mounting prism contains the camera apparatus.

9. The man-hole camera system according to claim 8
wherein the camera apparatus is an electric device;
wherein the camera apparatus is a sensor;
wherein the camera apparatus is an image capture device;
wherein the camera apparatus illuminates the underground space maintained by the utility system;
wherein the camera apparatus captures images from the underground space maintained by the utility system for analysis and review.

10. (canceled)

11. (canceled)

12. (canceled)

13. (canceled)

14. The man-hole camera system according to claim 9
wherein the logic module is a programmable electronic device;
wherein the communication module is a wireless electronic communication device that allows the logic module to wirelessly communicate with the personal data device;
wherein the communication module establishes a wireless communication link between the camera apparatus and the personal data device;
wherein the logic module controls the operation of the communication module;
wherein the logic module controls the operation of the plurality of LEDs;
wherein the logic module controls the operation of the motor structure;
wherein the logic module controls the operation of the image sensor;
wherein the personal data device uses the wireless communication link to transmit operating instruction to the logic module through the communication module;
wherein the logic module receives and processes the captured images generated by the image sensor;
wherein the logic module transmits the images captured from the image sensor to the personal data device using the communication module and the wireless communication link.

15. The man-hole camera system according to claim 9
wherein the logic module controls the illumination generated by the camera apparatus by controlling the operation of the plurality of LEDs;
wherein the logic module controls the positioning of the field of view of the image sensor by controlling the operation of the motor structure;
wherein the logic module controls an axis of rotation of the motor structure such that the field of view of the image sensor rotates around the center axis of the mounting prism.

16. The man-hole camera system according to claim 15
wherein each of the plurality of LEDs is an electric circuit element;
wherein the plurality of LEDs generate a field of illumination within the underground space maintained by the utility system;
wherein each LED selected from the plurality of LEDs illuminates when an electric current passes through the selected LED.

17. The man-hole camera system according to claim 16
wherein the motor structure is an electromechanical device;
wherein the motor structure is a rotating device;
wherein the image sensor attaches to the motor structure such that the rotation of the motor structure will rotate the field of view of the image sensor around an axis of rotation that is aligned with the center axis of the prism structure of the mounting prism;
wherein the motor structure rotates the field of view of the image sensor by rotating the image sensor around a full 360 degree arc centered on the axis of rotation.

18. The man-hole camera system according to claim 17
wherein the motor structure further comprises a servo motor and a motor controller;
wherein the servo motor is an electric motor;
wherein the motor controller is an electric circuit that controls the speed of rotation, the direction of rotation, and the angular position of the rotor of the servo motor;
wherein the servo motor is a rotating device;
wherein the servo motor attaches to a congruent end of the mounting prism such that the rotation of the servo motor aligns with the center axis of the mounting prism;
wherein the motor controller receives inputs from the logic module and converts those inputs into the mechanical actions taken by the servo motor;
wherein the image sensor is an electric sensor.

19. The man-hole camera system according to claim 18
wherein the image sensor receives light from the exterior of the image sensor and converts the received light into a digital representation of sufficient detail to allow the logic module to transmit a reproduction of the source of the captured light to the personal data device;
wherein the image sensor transmits the captured images to the logic module;
wherein the image sensor attaches to the motor structure such that the motor structure will rotate the image sensor;
wherein the image sensor attaches directly to the servo motor of the motor structure.

20. The man-hole camera system according to claim 19
wherein the telescopic handle is a telescopic structure that further comprises a third arm and a second detent;
wherein the second detent is a mechanical device that locks and secures the third arm to the second arm;
wherein the second arm is a hollow prism that is further defined with an inner dimension;
wherein the third arm is a hollow prism that is further defined with an outer dimension;
wherein the third arm is geometrically similar to the second arm;
wherein the span of the outer dimension of the third arm is lesser than the span of the inner dimension of the second arm such that the third arm inserts into the second arm in a telescopic fashion to form a composite prism structure;
wherein the span of the length of the telescopic handle adjusts by adjusting the relative position of the third arm within the second arm;
wherein the position of the third arm relative to the second arm is held in position using the second detent.
